(19) United States
(12) Patent Application Publication
(10) Pub. No.: US 2024/0141980 A1
(43) Pub. Date: May 2, 2024

(54) MOTOR SHAFT WITH AN INTERNAL AXLE DIFFERENTIATING CAPABILITY

(71) Applicant: Bryan Prucher, Clarkston, MI (US)

(72) Inventor: Bryan Prucher, Clarkston, MI (US)

(21) Appl. No.: 18/406,381

(22) Filed: Jan. 8, 2024

Related U.S. Application Data
(63) Continuation-in-part of application No. 17/852,732, filed on Jun. 29, 2022, now Pat. No. 11,870,322.

(51) Int. Cl. F16H 57/037; F16H 48/40; F16H 57/04

(52) U.S. Cl. CPC F16H 57/037; F16H 48/40; F16H 57/0493

(57) ABSTRACT

A central differential power output delivery shaft for a rotary motor used to deliver the power to the drive wheels in a motor vehicle application. The power delivery shaft is a hollow two piece housing which internally houses two separate independent axle shafts, one protruding from each of its ends for the purpose of providing differentiated rotation to the drive wheels of a motor vehicle. The axle shafts rotate along with the central differential power output delivery shaft and are internally operationally connected to the left hand and right drive wheels of the motor vehicle. The axle shafts are also operationally connected to each other inside the central differential power output delivery shaft housing with a geared differentiating arrangement so as to allow them to rotate at different rates with respect to one another.

### CROSS REFERENCE TO RELATED APPLICATION

This application is a continuation in-part application of copending U.S. patent application Ser. No. 17/852,732 filed Jun. 29, 2022, 4 Stack Motor Cluster, the disclosure of which is hereby incorporated by reference, in its entirety, including the drawings.

### PRIOR ART

A dual radial gap motor such as disclosed in U.S. Pat. No. 9,124,144. (the ‘144’ Patent”) defines a dual radial gap DC motor/generator that is functionally both an inside and outside rotor motor packaged within the same housing. The motor therein includes a rotor having at least two spaced apart annular rings each with an inner surface and an outer surface. The rotor has an array of permanent magnets with alternating polarities and a common central axis. The annular rings are operationally attached to a central differential power output delivery shaft. The motor also includes a stator having a circular array of induction coils sharing the same rotational axis as the rotor. The stator is encircled by the annular rings and centrally positioned so that there are equal gaps between the induction coils and the magnets of both rings. The interaction between the rotor magnets and the stator coils, when energized, produces two separate radial torque components that act collectively to produce a final output torque.

Mathematically, power is calculated by multiplying torque times RPM and dividing by a constant. A conventional electric motor has only one radial torque component. Having two radial torque components enables a dual radial gap motor to produce up to twice the power of a conventional electric motor of the same size at the same RPM or inversely, a conventional electric motor would need to rotate at twice the RPM to produce the same power.

In a motor vehicle application, the high power and low RPM requirements of the wheels that drive a vehicle are not compatible with the those of a conventional electric motor without providing it with supplemental gear reduction. The high power, low RPM combination characteristics of a dual radial gap motor makes it ideal for a direct drive motor to wheel application. Direct drive in a motor vehicle application has the advantage of reducing cost and complexity by eliminating the need for a transmission and various other subsequent power train components known to those familiar with the art.

An additional motor vehicle requirement is that when it is in motion and is making a turn, the left and right wheels must rotate at different rates with respect to one another to avoid wheel slippage and tire damage. For example, when a motor vehicle is in-motion and making a turn to the right, the left wheel must rotate faster and make more rotations because it has farther to travel. The right wheel will rotate slower and make fewer rotations as it has less distance to travel. The opposite is true when the vehicle is turning to the left. This rotational wheel rate variation requirement in motor vehicles is accommodated by a differential unit mechanism mounted between the motor and the wheels. A differential unit is a mechanism that accommodates turns by allowing the drive wheels to rotate at different speeds with respect to one another while receiving power and motion at a constant rotation rate from the motor. In a direct drive application, to reduce system complexity, It would be desirable to incorporate the differential action along with its associated mechanism internally within the motor central power output shaft that is internal to the motor. It is this to which the present invention is directed.

### BACKGROUND

The present invention relates to a differential power output shaft for a dual radial gap motor or other motor. More specifically, the present invention pertains to an internal differential system internally within the central differential power output delivery shaft of a motor and particularly a dual radial gap motor used to power a motor vehicle.

### SUMMARY OF THE INVENTION

According to the present invention, a central differential power output delivery shaft for a motor having a differential capability when delivering power directly to the drive wheels of a motor vehicle comprises a hollow two part power shaft which houses (a) a pair of axle gears; (b) a pair of pinion gears; (c) a pinion axle; (d) a roll pin and (e) support bushings, all being contained completely internal to the motor central differential power output delivery shaft, itself. Bearings may be used in lieu of the bushings.

For a more complete understanding of the present disclosure, reference is made to the following detailed description and accompanying drawings. In the drawings, like reference characters refer to like parts throughout the several views in which:

### BRIEF DESCRIPTION OF THE DRAWINGS

FIG. 1 is a plan view of an exemplary dual radial gap motor;

FIG. 2 is a plan view of the central differential power output delivery shaft;

FIG. 3 is a cross-section view of central differential power output delivery shaft Taken along the line B-B of FIG. 2 without the internal differential components;

FIG. 4 is a cross-section view taken along the line B-B of FIG. 2 of the central differential power output delivery shaft with all the differential components and axle shafts included;

FIG. 5 is a view of the internal components of the central differential power output delivery shaft showing how the differential capability is provided to the axles; and

FIG. 6 is an exploded view showing the method of engagement between the axle shafts and the axle gears.

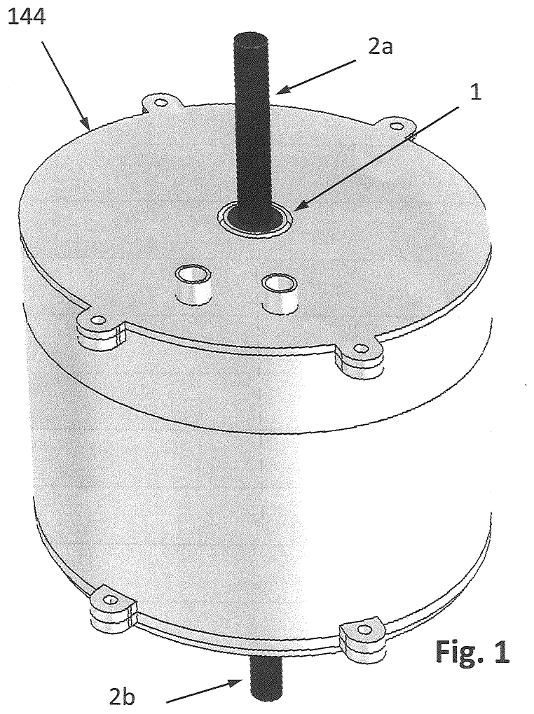

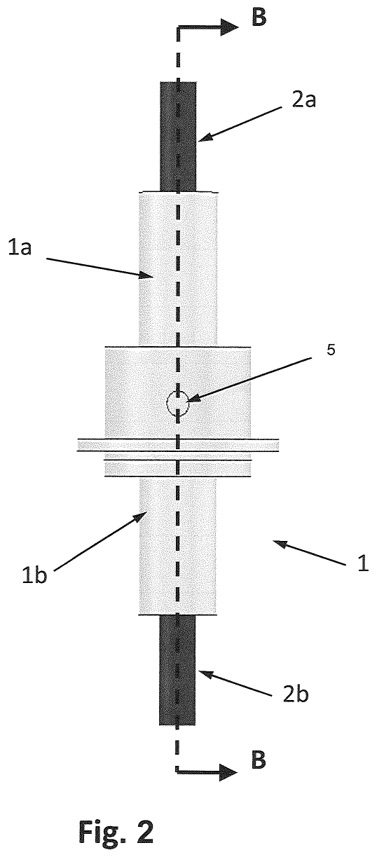

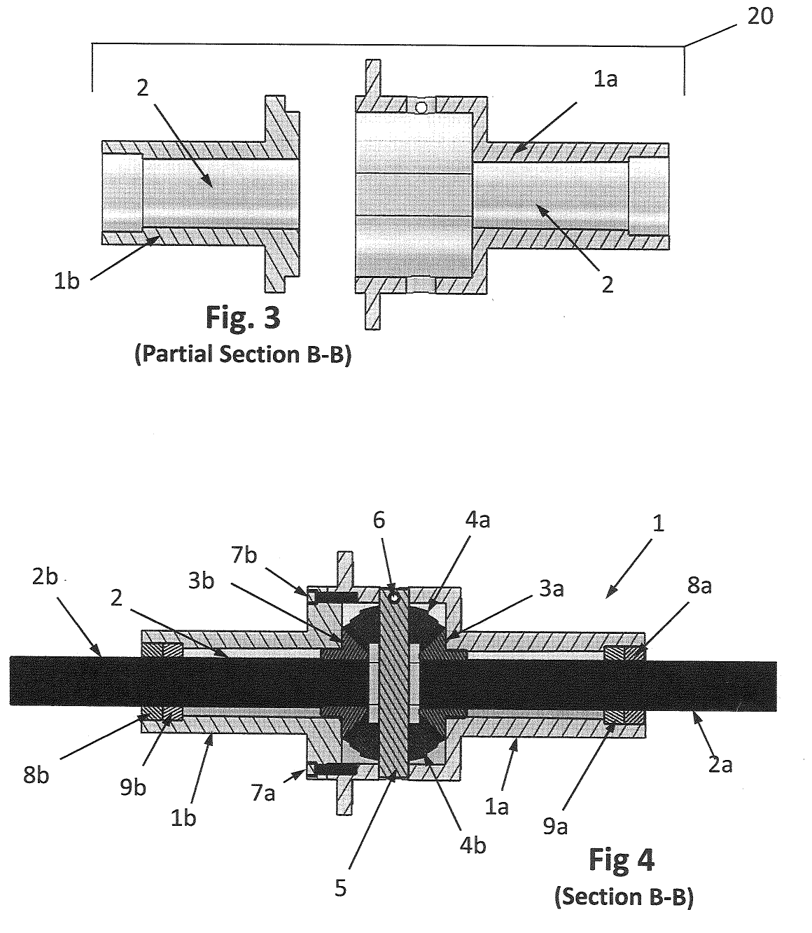

### DESCRIPTION OF THE INVENTION

At the outset it is to be noted that the present invention is described with reference to the dual motor gap of “144 patent” but is not to be construed as so-limited.

Referring now to the drawings, a motor vehicle (not shown) includes a pair of output axle shafts 2a and 2b that are housed in a centrally located central differential power output delivery shaft 1. The shafts 2a and 2b are operationally attached to the drive wheels of the motor vehicle.

The central differential power output delivery shaft 1 comprises two housing sections, namely an upper housing 1a and a lower housing 1b.

As shown in FIG. 4, the differential power output delivery shaft 1 has a central longitudinal cavity 2 extending along its entire length. The shafts 2a and 2b extrend into the delivery shaft 1, as shown. The shaft 1 houses (a) axle gears 3a and 3b; (b) pinion gears 4a and 4b; (c) a pinion axle shaft 5; and (d) a roll pin 6, which are necessary for it to function as both a motor power output component and a powertrain differential unit with output shaft rotational differentiating capability being housed therewithin.

The two separate axle shafts 2a and 2b are rotated in unison with the central motor differential power output shaft 1, but rotate independent of one another by bearings, bronze bushings or the like 8a and 8b.

The axle gears 3a and 3b and the pinion gears 4a and 4b are lubricated by either an application of grease or a fluid lubricant, well known to those familiar with the art, that is contained within the cavity 2 by seals 9a and 9b.

To facilitate its assembly, the central differential power output delivery shaft housings 1a and 1b are mechanically secured together by fasteners 7a and 7b.

As noted above, shaft 1 comprises an internal cluster of gears 3a and 3b and pinion gears 4a and 4b, that provide for the rotational differentiation of the two separate, individual axle shafts 2a and 2b. The axle shafts 2a and 2b have splined ends 10b and 10a respectively and have a variety of configurations, i.e., straight, segmented, etc. The two axle gears 3a and 3b have internal splines or bores 11a and 11b, respectively. The pinion gears 4a and 4b are smooth bored. The pinion gear central shaft 5, itself is secured in place to the upper housing 1a by the roll pin 6. As noted, the axle shaft 2a, is operationally secured and allowed to rotate within the upper housing 1a by the ball bearings 8a. Similarly, the axle shaft 2b is operationally secured and allowed to rotate within the lower housing 1b by ball bearings 8b.

The pinion gear axle shaft 5 operationally engages all the inner active gear components, i.e., the axle shafts 2a and 2b, the axle gears 3a and 3b, and the pinion gears 4a, and 4b with the central differential power output delivery shaft 1. When the central differential power output delivery shaft 1 is rotated by the motor all the internal components rotate along with it.

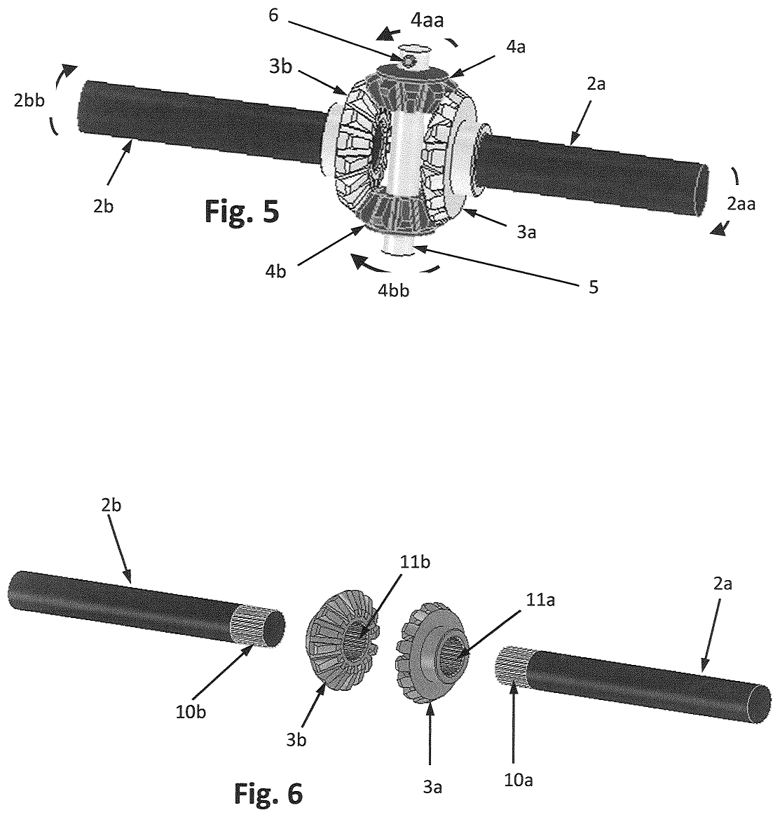

Referring now to FIG. 5 which illustrates how the axle shafts 2a and 2b are operationally engaged with the axle gears 3a and 3b. The differential action between the two axle shafts 2a and 2b is facilitated by the pinion gears 4a and 4b that pivot around the central shaft 5 that is fixed axially in position to the motor central differential power output delivery shaft 1 with the roll pin 6. When axle shaft 2a and its corresponding axle gear 3a rotate in the direction 2aa, the axle shaft 2b and its corresponding axle gear 3b rotate in the opposite direction 2bb. This results from the interlocking pinion gear 4a, fixed axially in position by the central shaft 5 being rotated in the direction 4aa and interlocking pinion gear 4b, also fixed axially in position by the central shaft 5, being rotated in the opposite direction 4bb.

When one axle is rotated in one direction, the other axle rotates in the opposite direction. In this manner, the motor central differential power output delivery shaft 1 and its internal components can be rotated at a constant speed while allowing the axle shafts 2a and 2b to rotate at different speeds with respect to one another.

FIG. 6 shows that the axle shafts 2a and 2b are operationally affixed to the axle gears 3a and 3b by inserting the splined end 10a of axle shaft 2a into the matching splined bore 11a of the corresponding axle gear 3a and inserting the splined end 10b of axle shaft 2b into the matching splined bore 11b of the corresponding axle gear 3b.

This results in reducing motor vehicle powertrain complexity, improves operating efficiency and makes the motor a more functionally relevant powertrain component.

1. A central differential power output delivery motor shaft comprising:
(a) a hollow delivery shaft defining a housing which houses a plurality of gear set components, including:
(i) a pair of axle gears;
(ii) a pair of pinion gears;
(iii) a pinion axle shaft;
(iv) a roll pin; and
(b) means for supporting the axle gears, pinion gears, pinion axle shaft and roll pin.

2. The central differential power output delivery motor shaft of claim 1 which further comprises:
(a) a lubricant disposed within the housing, and
(b) a plurality of seals for retaining the lubricant within the housing.

3. The central differential power output delivery motor shaft of claim 1 wherein the means for supporting is at least one of a bushing or a bearing.

4. The central differential power output delivery motor shaft of claim 1 wherein the delivery shaft is a two piece housing, each housing piece is hollow, the pieces cooperating to house the gear set components therewithin.

5. The central differential power output delivery motor shaft of claim 1 wherein each axle gear has a splined bore.

6. The central differential power output delivery motor shaft of claim 5 wherein the pinion gears are smooth bores.

7. The central differential power output delivery motor shaft of claim 1 wherein each axle gear has a splined bore and the pinion gears have a smooth bore.

8. The central differential power output delivery motor shaft of claim 4 wherein one axle shaft is rotatable within one piece of the housing and the other axle shaft is rotatable in the other piece of the housing.

9. The central differential power output delivery motor shaft of claim 1 wherein the pinion gear axle shaft engages the housing axle shafts, the housing axle gears and the pinion axle gears.

10. A dual radial gap DC motor/generator comprising:
the central differential power output delivery motor shaft of claim 1.
